(19) United States
(12) Patent Application Publication
(10) Pub. No.: US 2020/0047529 A1
(43) Pub. Date: Feb. 13, 2020

(54) PRINTING APPARATUS, CLEANING DEVICE, AND PRINTING METHOD

(71) Applicant: CANON KABUSHIKI KAISHA, Tokyo (JP)

(72) Inventors: Ryosuke Araki, Kawasaki-shi (JP); Shunya Sunouchi, Machida-shi (JP)

(21) Appl. No.: 16/526,442

(22) Filed: Jul. 30, 2019

(30) Foreign Application Priority Data
Aug. 7, 2018 (JP) 2018-148706

(51) Int. Cl. B41J 29/17; B41J 2/005

(52) U.S. Cl. CPC B41J 29/17; B41J 2/0057

(57) ABSTRACT

There is provided with a printing apparatus. A transfer member cyclically passes a formation area and a transfer area of an ink image. A print unit forms an ink image on the transfer member by discharging ink to the transfer member in the formation area. A conveyance drum conveys a print medium and to which an ink image is transferred from the transfer member in the transfer area. A cleaning unit cleans the conveyance drum at a cleaning position where the cleaning unit contacts the conveyance drum. A displacing unit separates the cleaning unit from the cleaning position when the print medium passes the cleaning position.

### BACKGROUND OF THE INVENTION

### Field of the Invention

The present invention relates to a printing apparatus, a cleaning device, and a printing method.

### Description of the Related Art

There has been proposed a technique for, in a printing apparatus in which a print medium is conveyed to a printing position by a conveyance drum, cleaning a deposit adhered to the conveyance drum. Japanese Patent Laid-Open No. 2012-159733 discloses a technique for cleaning a conveyance drum simultaneously with a printing operation.

If a cleaning position can be set to an arbitrary position on the conveyance drum, the degree of freedom in design is improved. However, in the arrangement described in Japanese Patent Laid-Open No. 2012-159733, when the cleaning position is set on the conveyance path of a print medium, there is a problem that the print medium interferes with the cleaning device during a printing operation.

### SUMMARY OF THE INVENTION

An embodiment of the present invention provides a technique for cleaning a conveyance drum while avoiding interference with a print medium even during a printing operation.

According to an embodiment of the present invention, a printing apparatus comprising: a transfer member configured to cyclically pass a formation area and a transfer area of an ink image; a print unit configured to form an ink image on the transfer member by discharging ink to the transfer member in the formation area; a conveyance drum configured to convey a print medium and to which an ink image is transferred from the transfer member in the transfer area; a cleaning unit configured to clean the conveyance drum at a cleaning position where the cleaning unit contacts the conveyance drum; and a displacing unit configured to separate the cleaning unit from the cleaning position when the print medium passes the cleaning position.

According to another embodiment of the present invention, a cleaning device configured to clean a conveyance drum that conveys a print medium in a printing apparatus, wherein the printing apparatus includes: a transfer member configured to cyclically pass a formation area and a transfer area of an ink image; and a print unit configured to form an ink image on the transfer member by discharging ink to the transfer member in the formation area, an ink image is transferred from the transfer member to the conveyance drum in the transfer area, and the cleaning device comprises: a cleaning unit configured to clean the conveyance drum; and a displacing unit configured to separate the cleaning unit from the conveyance drum when the print medium passes a position where the cleaning unit cleans the conveyance drum.

According to still another embodiment of the present invention, a printing method of a printing apparatus, the printing apparatus including: a transfer member configured to cyclically pass a formation area and a transfer area of an ink image; a print unit configured to form an ink image on the transfer member by discharging ink to the transfer member in the formation area; and a conveyance drum configured to convey a print medium and to which an ink image is transferred from the transfer member in the transfer area, the printing method comprising: printing an image on a print medium while conveying the print medium by a conveyance drum; cleaning the conveyance drum; and displacing by separating a cleaning unit configured to clean the conveyance drum from the conveyance drum when the print medium passes a cleaning position of the conveyance drum in the cleaning.

Further features of the present invention will become apparent from the following description of exemplary embodiments (with reference to the attached drawings).

### BRIEF DESCRIPTION OF THE DRAWINGS

FIG. 1 is a schematic view of a printing system;

FIG. 2 is a perspective view of a print unit;

FIG. 3 is an explanatory view of a displacement mode of the print unit in FIG. 2;

FIG. 4 is a block diagram of the control system of the printing system in FIG. 1;

FIG. 5 is a block diagram of the control system of the printing system in FIG. 1;

FIG. 6 is an explanatory view showing an example of the operation of the printing system in FIG. 1;

FIG. 7 is an explanatory view showing an example of the operation of the printing system in FIG. 1;

FIG. 8A is a view showing a state in which a cleaning device is in contact with a pressurizing drum;

FIG. 8B is a view showing a state in which the cleaning device and the pressurizing drum are separated;

FIG. 9A is a view showing a conveyance path through which a print medium passes when performing printing on the print medium;

FIG. 9B is a view showing a conveyance path through which a print medium P passes when the print medium P is reversed and conveyed to a printing position after printing on the obverse surface at the time of double-sided printing;

FIG. 10 is a perspective view showing the arrangement of a gripping unit;

FIG. 11A is an explanatory view showing the flow of a print medium at the time of double-sided printing;

FIG. 11B is an explanatory view showing the flow of a print medium at the time of double-sided printing;

FIG. 11C is an explanatory view showing the flow of a print medium at the time of double-sided printing;

FIG. 11D is an explanatory view showing the flow of a print medium at the time of double-sided printing;

FIG. 11E is an explanatory view showing the flow of a print medium at the time of double-sided printing;

FIG. 12 is a flowchart showing the operation of the cleaning device; and

FIG. 13 is a schematic view of a printing system in the second embodiment.

### DESCRIPTION OF THE EMBODIMENTS

### First Embodiment

Embodiments of the present invention will be described with reference to the accompanying drawings. In each view, arrows X and Y indicate horizontal directions perpendicular to each other. An arrow Z indicates a vertical direction.

### Printing System

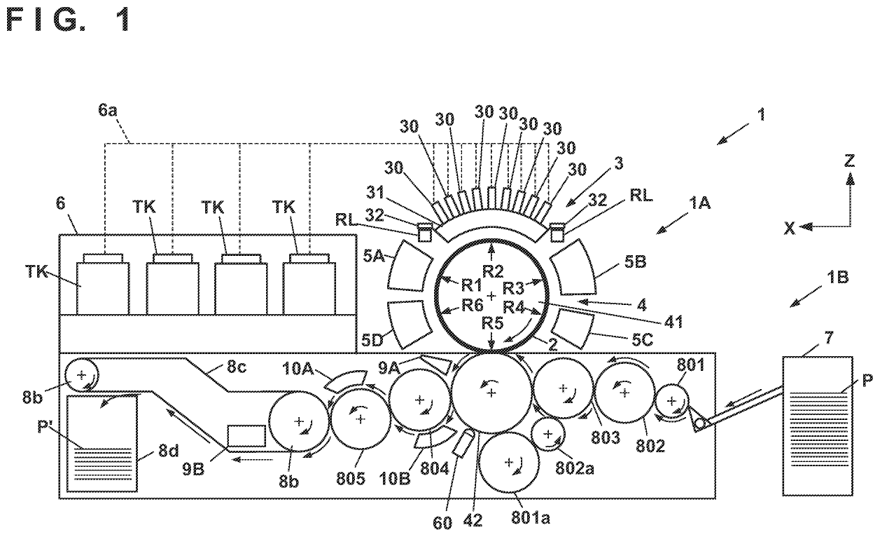

FIG. 1 is a front view schematically showing a printing system (printing apparatus) 1 according to an embodiment of the present invention. The printing system 1 is a sheet inkjet printer that forms (manufactures) a printed product P′ by transferring an ink image to a print medium P via a transfer member 2. The printing system 1 includes a printing apparatus 1A and a conveyance apparatus 1B. In this embodiment, an X direction, a Y direction, and a Z direction indicate the widthwise direction (total length direction), the depth direction, and the height direction of the printing system 1, respectively. The print medium P is conveyed in the X direction.

Note that “print” includes not only formation of significant information such as a character or graphic pattern but also formation of an image, design, or pattern on print media in a broader sense or processing of print media regardless of whether the information is significant or insignificant or has become obvious to allow human visual perception. In this embodiment, “print media” are assumed to be paper sheets but may be fabrics, plastic films, and the like.

An ink component is not particularly limited. In this embodiment, however, a case is assumed in which aqueous pigment ink that includes a pigment as a coloring material, water, and a resin is used.

### Printing Apparatus

The printing apparatus 1A includes a print unit 3, a transfer unit 4, peripheral units 5A to 5D, and a supply unit 6.

### Print Unit

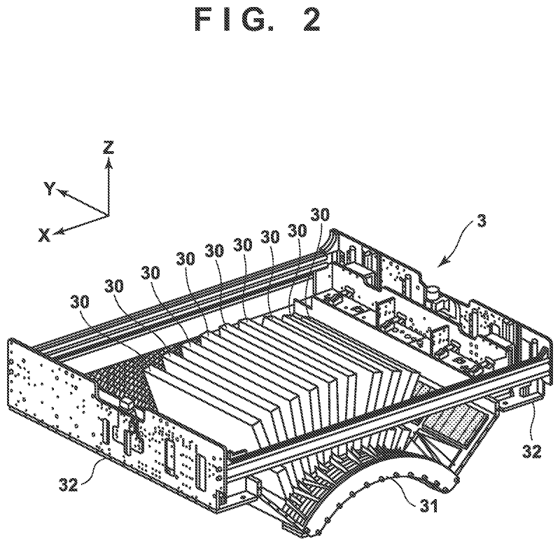

The print unit 3 includes a plurality of printheads 30 and a carriage 31. A description will be made with reference to FIGS. 1 and 2. FIG. 2 is perspective view showing the print unit 3. The printheads 30 discharge liquid ink to the transfer member 2 and form ink images of a printed image on the transfer member 2.

In this embodiment, each printhead 30 is a full-line head elongated in the Y direction, and nozzles are arrayed in a range where they cover the width of an image printing area of a print medium having a usable maximum size. Each printhead 30 has an ink discharge surface with the opened nozzle on its lower surface, and the ink discharge surface faces the surface of the transfer member 2 via a minute gap (for example, several mm). In this embodiment, the transfer member 2 is configured to move on a circular orbit cyclically, and thus the plurality of printheads 30 are arranged radially.

Each nozzle includes a discharge element. The discharge element is, for example, an element that generates a pressure in the nozzle and discharges ink in the nozzle, and the technique of an inkjet head in a well-known inkjet printer is applicable. For example, an element that discharges ink by causing film boiling in ink with an electrothermal transducer and forming a bubble, an element that discharges ink by an electromechanical transducer (piezoelectric element), an element that discharges ink by using static electricity, or the like can be given as the discharge element. A discharge element that uses the electrothermal transducer can be used from the viewpoint of high-speed and high-density printing.

In this embodiment, nine printheads 30 are provided. The respective printheads 30 discharge different kinds of inks. The different kinds of inks are, for example, different in coloring material and include yellow ink, magenta ink, cyan ink, black ink, and the like. One printhead 30 discharges one kind of ink. However, one printhead 30 may be configured to discharge the plurality of kinds of inks. When the plurality of printheads 30 are thus provided, some of them may discharge ink (for example, clear ink) that does not include a coloring material.

The carriage 31 supports the plurality of printheads 30. The end of each printhead 30 on the side of an ink discharge surface is fixed to the carriage 31. This makes it possible to maintain a gap on the surface between the ink discharge surface and the transfer member 2 more precisely. The carriage 31 is configured to be displaceable while mounting the printheads 30 by the guide of each guide unit RL. In this embodiment, the guide units RL are rail-like structures elongated in the Y direction and provided as a pair separately in the X direction. A slide portion 32 is provided on each side of the carriage 31 in the X direction. The slide portions 32 engage with the guide members RL and slide along the guide members RL in the Y direction.

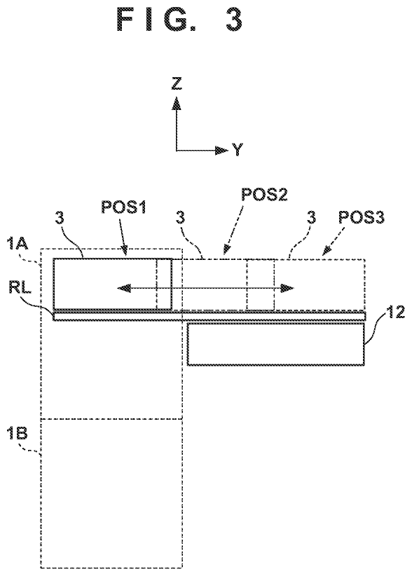

FIG. 3 is a view showing a displacement mode of the print unit 3 and schematically shows the right side surface of the printing system 1. A recovery unit 12 is provided in the rear of the printing system 1. The recovery unit 12 has a mechanism for recovering discharge performance of the printheads 30. For example, a cap mechanism which caps the ink discharge surface of each printhead 30, a wiper mechanism which wipes the ink discharge surface, a suction mechanism which sucks ink in the printhead 30 by a negative pressure from the ink discharge surface can be given as such mechanisms.

The guide unit RL is elongated over the recovery unit 12 from the side of the transfer member 2. By the guide of the guide unit RL, the print unit 3 is displaceable between a discharge position POS1 at which the print unit 3 is indicated by a solid line and a recovery position POS3 at which the print unit 3 is indicated by a broken line, and is moved by a driving mechanism (not shown).

The discharge position POS1 is a position at which the print unit 3 discharges ink to the transfer member 2 and a position at which the ink discharge surface of each printhead 30 faces the surface of the transfer member 2. The recovery position POS3 is a position retracted from the discharge position POS1 and a position at which the print unit 3 is positioned above the recovery unit 12. The recovery unit 12 can perform performance recovery processing on the printheads 30 when the print unit 3 is positioned at the recovery position POS3. In this embodiment, the recovery unit 12 can also perform the recovery processing in the middle of movement before the print unit 3 reaches the recovery position POS3. There is a preliminary recovery position POS2 between the discharge position POS1 and the recovery position POS3. The recovery unit 12 can perform preliminary recovery processing on the printheads 30 at the preliminary recovery position POS2 while the printheads 30 move from the discharge position POS1 to the recovery position POS3.

### Transfer Unit

The transfer unit 4 will be described with reference to FIG. 1. The transfer unit 4 includes a transfer drum (transfer cylinder) 41 and a pressurizing drum (conveyance drum) 42. Each of these drums is a rotating body that rotates about a rotation axis in the Y direction and has a columnar outer peripheral surface. In FIG. 1, arrows shown in respective views of the transfer drum 41 and the pressurizing drum 42 indicate their rotation directions. The transfer drum 41 rotates clockwise, and the pressurizing drum 42 rotates anticlockwise.

The transfer drum 41 is a support member that supports the transfer member 2 on its outer peripheral surface. The transfer member 2 is provided on the outer peripheral surface of the transfer drum 41 continuously or intermittently in a circumferential direction. If the transfer member 2 is provided continuously, it is formed into an endless swath. If the transfer member 2 is provided intermittently, it is formed into swaths with ends dividedly into a plurality of segments. The respective segments can be arranged in an arc at an equal pitch on the outer peripheral surface of the transfer drum 41.

The transfer member 2 moves cyclically on the circular orbit by rotating the transfer drum 41. By the rotational phase of the transfer drum 41, the position of the transfer member 2 can be discriminated into a processing area R1 before discharge, a discharge area R2, processing areas R3 and R4 after discharge, a transfer area R5, and a processing area R6 after transfer. The transfer member 2 passes through these areas cyclically.

The processing area R1 before discharge is an area where preprocessing is performed on the transfer member 2 before the print unit 3 discharges ink and an area where the peripheral unit 5A performs processing. In this embodiment, a reactive liquid is applied. The discharge area R2 is a formation area where the print unit 3 forms an ink image by discharging ink to the transfer member 2. The processing areas R3 and R4 after discharge are processing areas where processing is performed on the ink image after ink discharge. The processing area R3 after discharge is an area where the peripheral unit 5B performs processing, and the processing area R4 after discharge is an area where the peripheral unit 5C performs processing. The transfer area R5 is an area where the transfer unit 4 transfers the ink image on the transfer member 2 to the print medium P. The processing area R6 after transfer is an area where post processing is performed on the transfer member 2 after transfer and an area where the peripheral unit 5D performs processing.

In this embodiment, the discharge area R2 is an area with a predetermined section. The other areas R1 and R3 to R6 have narrower sections than the discharge area R2. Comparing to the face of a clock, in this embodiment, the processing area R1 before discharge is positioned at almost 10 o'clock, the discharge area R2 is in a range from almost 11 o'clock to 1 o'clock, the processing area R3 after discharge is positioned at almost 2 o'clock, and the processing area R4 after discharge is positioned at almost 4 o'clock. The transfer area R5 is positioned at almost 6 o'clock, and the processing area R6 after transfer is an area at almost 8 o'clock.

The transfer member 2 may be formed by a single layer but may be an accumulative body of a plurality of layers. If the transfer member 2 is formed by the plurality of layers, it may include three layers of, for example, a surface layer, an elastic layer, and a compressed layer. The surface layer is an outermost layer having an image formation surface where the ink image is formed. By providing the compressed layer, the compressed layer absorbs deformation and disperses a local pressure fluctuation, making it possible to maintain transferability even at the time of high-speed printing. The elastic layer is a layer between the surface layer and the compressed layer.

As a material for the surface layer, various materials such as a resin and a ceramic can be used appropriately. In respect of durability or the like, however, a material high in compressive modulus can be used. More specifically, an acrylic resin, an acrylic silicone resin, a fluoride-containing resin, a condensate obtained by condensing a hydrolyzable organosilicon compound, and the like can be given. The surface layer that has undergone a surface treatment may be used in order to improve wettability of the reactive liquid, the transferability of an image, or the like. Frame processing, a corona treatment, a plasma treatment, a polishing treatment, a roughing treatment, an active energy beam irradiation treatment, an ozone treatment, a surfactant treatment, a silane coupling treatment, or the like can be given as the surface treatment. A plurality of them may be combined. It is also possible to provide any desired surface shape in the surface layer.

For example, acrylonitrile-butadiene rubber, acrylic rubber, chloroprene rubber, urethane rubber, silicone rubber, or the like can be given as a material for the compressed layer. When such a rubber material is formed, a porous rubber material may be formed by blending a predetermined amount of a vulcanizing agent, vulcanizing accelerator, or the like and further blending a foaming agent, or a filling agent such as hollow fine particles or salt as needed. Consequently, a bubble portion is compressed along with a volume change with respect to various pressure fluctuations, and thus deformation in directions other than a compression direction is small, making it possible to obtain more stable transferability and durability. As the porous rubber material, there are a material having an open cell structure in which respective pores continue to each other and a material having a closed cell structure in which the respective pores are independent of each other. However, either structure may be used, or both of these structures may be used.

As a member for the elastic layer, the various materials such as the resin and the ceramic can be used appropriately. In respect of processing characteristics, various materials of an elastomer material and a rubber material can be used. More specifically, for example, fluorosilicone rubber, phenyl silicone rubber, fluorine rubber, chloroprene rubber, urethane rubber, nitrile rubber, and the like can be given. In addition, ethylene propylene rubber, natural rubber, styrene rubber, isoprene rubber, butadiene rubber, the copolymer of ethylene/propylene/butadiene, nitrile-butadiene rubber, and the like can be given. In particular, silicone rubber, fluorosilicone rubber, and phenyl silicon rubber are advantageous in terms of dimensional stability and durability because of their small compression set. They are also advantageous in terms of transferability because of their small elasticity change by a temperature.

Between the surface layer and the elastic layer and between the elastic layer and the compressed layer, various adhesives or double-sided adhesive tapes can also be used in order to fix them to each other. The transfer member 2 may also include a reinforce layer high in compressive modulus in order to suppress elongation in a horizontal direction or maintain resilience when attached to the transfer drum 41. Woven fabric may be used as a reinforce layer. The transfer member 2 can be manufactured by combining the respective layers formed by the materials described above in any desired manner.

The outer peripheral surface of the pressurizing drum 42 is pressed against the transfer member 2. The pressurizing drum 42 conveys the print medium P to the transfer area R5, at least one gripping unit 8e which grips the leading edge portion of the print medium P is provided on the outer peripheral surface of the pressurizing drum 42. A plurality of gripping units 8e may be provided separately in the circumferential direction of the pressurizing drum 42. The ink image on the transfer member 2 is transferred to the print medium P when it passes through a nip portion between the pressurizing drum 42 and the transfer member 2 while being conveyed in tight contact with the outer peripheral surface of the pressurizing drum 42. In addition, the detail of the gripping unit 8e is mentioned later.

The transfer drum 41 and the pressurizing drum 42 can share a driving source such as a motor that drives them, and a driving force can be delivered by a transmission mechanism such as a gear mechanism.

### Peripheral Unit

The peripheral units 5A to 5D are arranged around the transfer drum 41. In this embodiment, the peripheral units 5A to 5D are specifically an application unit, an absorption unit, a heating unit, and a cleaning unit in order.

The application unit 5A is a mechanism which applies the reactive liquid onto the transfer member 2 before the print unit 3 discharges ink. The reactive liquid is a liquid that contains a component increasing an ink viscosity. An increase in ink viscosity here means that a coloring material, a resin, and the like that form the ink react chemically or suck physically by contacting the component that increases the ink viscosity, recognizing the increase in ink viscosity. This increase in ink viscosity includes not only a case in which an increase in viscosity of entire ink is recognized but also a case in which a local increase in viscosity is generated by coagulating some of components such as the coloring material and the resin that form the ink.

The component that increases the ink viscosity can use, without particular limitation, a substance such as metal ions or a polymeric coagulant that causes a pH change in ink and coagulates the coloring material in the ink, and can use an organic acid. For example, a roller, a printhead, a die coating apparatus (die coater), a blade coating apparatus (blade coater), or the like can be given as a mechanism which applies the reactive liquid. If the reactive liquid is applied to the transfer member 2 before the ink is discharged to the transfer member 2, it is possible to immediately fix ink that reaches the transfer member 2. This makes it possible to suppress bleeding caused by mixing adjacent inks.

The absorption unit 5B is a mechanism which absorbs a liquid component from the ink image on the transfer member 2 before transfer. It is possible to suppress, for example, a blur of an image printed on the print medium P by decreasing the liquid component of the ink image. Describing a decrease in liquid component from another point of view, it is also possible to represent it as condensing ink that forms the ink image on the transfer member 2. Condensing the ink means increasing the content of a solid content such as a coloring material or a resin included in the ink with respect to the liquid component by decreasing the liquid component included in the ink.

The absorption unit 5B includes, for example, a liquid absorbing member that decreases the amount of the liquid component of the ink image by contacting the ink image. The liquid absorbing member may be formed on the outer peripheral surface of the roller or may be formed into an endless sheet-like shape and run cyclically. In terms of protection of the ink image, the liquid absorbing member may be moved in synchronism with the transfer member 2 by making the moving speed of the liquid absorbing member equal to the peripheral speed of the transfer member 2.

The liquid absorbing member may include a porous body that contacts the ink image. The pore size of the porous body on the surface that contacts the ink image may be equal to or smaller than 10 μm in order to suppress adherence of an ink solid content to the liquid absorbing member. The pore size here refers to an average diameter and can be measured by a known means such as a mercury intrusion technique, a nitrogen adsorption method, an SEM image observation, or the like. Note that the liquid component does not have a fixed shape, and is not particularly limited if it has fluidity and an almost constant volume. For example, water, an organic solvent, or the like contained in the ink or reactive liquid can be given as the liquid component.

The heating unit 5C is a mechanism which heats the ink image on the transfer member 2 before transfer. A resin in the ink image melts by heating the ink image, improving transferability to the print medium P. A heating temperature can be equal to or higher than the minimum film forming temperature (MFT) of the resin. The MFT can be measured by each apparatus that complies with a generally known method such as JIS K 6828-2: 2003 or ISO 2115: 1996. From the viewpoint of transferability and image robustness, the ink image may be heated at a temperature higher than the MFT by 10° C. or higher, or may further be heated at a temperature higher than the MFT by 20° C. or higher. The heating unit 5C can use a known heating device, for example, various lamps such as infrared rays, a warm air fan, or the like. An infrared heater can be used in terms of heating efficiency.

The cleaning unit 5D is a mechanism which cleans the transfer member 2 after transfer. The cleaning unit 5D removes ink remaining on the transfer member 2, dust on the transfer member 2, or the like. The cleaning unit 5D can use a known method, for example, a method of bringing a porous member into contact with the transfer member 2, a method of scraping the surface of the transfer member 2 with a brush, a method of scratching the surface of the transfer member 2 with a blade, or the like as needed. A known shape such as a roller shape or a web shape can be used for a cleaning member used for cleaning.

As described above, in this embodiment, the application unit 5A, the absorption unit 5B, the heating unit 5C, and the cleaning unit 5D are included as the peripheral units. However, cooling functions of the transfer member 2 may be applied, or cooling units may be added to these units. In this embodiment, the temperature of the transfer member 2 may be increased by heat of the heating unit 5C. If the ink image exceeds the boiling point of water as a prime solvent of ink after the print unit 3 discharges ink to the transfer member 2, performance of liquid component absorption by the absorption unit 5B may be degraded. It is possible to maintain the performance of liquid component absorption by cooling the transfer member 2 such that the temperature of the discharged ink is maintained below the boiling point of water.

The cooling unit may be an air blowing mechanism which blows air to the transfer member 2, or a mechanism which brings a member (for example, a roller) into contact with the transfer member 2 and cools this member by air-cooling or water-cooling. The cooling unit may be a mechanism which cools the cleaning member of the cleaning unit 5D. A cooling timing may be a period before application of the reactive liquid after transfer.

### Supply Unit

The supply unit 6 is a mechanism which supplies ink to each printhead 30 of the print unit 3. The supply unit 6 may be provided on the rear side of the printing system 1. The supply unit 6 includes a reservoir TK that reserves ink for each kind of ink. Each reservoir TK may be made of a main tank and a sub tank. Each reservoir TK and a corresponding one of the printheads 30 communicate with each other by a liquid passageway 6a, and ink is supplied from the reservoir TK to the printhead 30. The liquid passageway 6a may circulate ink between the reservoirs TK and the printheads 30. The supply unit 6 may include, for example, a pump that circulates ink. A deaerating mechanism which deaerates bubbles in ink may be provided in the middle of the liquid passageway 6a or in each reservoir TK. A valve that adjusts the fluid pressure of ink and an atmospheric pressure may be provided in the middle of the liquid passageway 6a or in each reservoir TK. The heights of each reservoir TK and each printhead 30 in the Z direction may be designed such that the liquid surface of ink in the reservoir TK is positioned lower than the ink discharge surface of the printhead 30.

### Conveyance Apparatus

The conveyance apparatus 1B is an apparatus that feeds the print medium P to the transfer unit 4 and discharges, from the transfer unit 4, the printed product P′ to which the ink image was transferred. The conveyance apparatus 1B includes a feeding unit 7, a plurality of conveyance drums 801 to 805, 801a and 802a, two sprockets 8b, a chain 8c, a collection unit 8d, and a cleaning device 60 described later. In FIG. 1, an arrow inside a view of each constituent element in the conveyance apparatus 1B indicates a rotation direction of the constituent element, and an arrow outside the view of each constituent element indicates a conveyance path of the print medium P or the printed product P′. The print medium P is conveyed from the feeding unit 7 to the transfer unit 4, and the printed product P′ is conveyed from the transfer unit 4 to the collection unit 8d. The side of the feeding unit 7 may be referred to as an upstream side in a conveyance direction, and the side of the collection unit 8d may be referred to as a downstream side.

The feeding unit 7 includes a stacking unit where the plurality of print media P are stacked and a feeding mechanism which feeds the print media P one by one from the stacking unit to the most upstream conveyance drum 801. Each of the conveyance drums 801 to 805, 801a and 802a is a rotating body that rotates about the rotation axis in the Y direction and has a columnar outer peripheral surface. At least one gripping unit 8e which grips the leading edge portion of the print medium P (printed product P′) is provided on the outer peripheral surface of each of the conveyance drums 801 to 805, 801a and 802a. A gripping operation and release operation of each gripping units 8e may be controlled such that the print medium P is transferred between the adjacent conveyance drums.

The two conveyance drums 801a and 802a are used to reverse the print medium P. When the print medium P undergoes double-side printing, it is not transferred to the conveyance drum 804 adjacent on the downstream side but transferred to the conveyance drums 801a from the pressurizing drum 42 after transfer onto the surface. The print medium P is reversed via the two conveyance drums 801a and 802a, and transferred to the pressurizing drum 42 again via the conveyance drums 803 on the upstream side of the pressurizing drum 42. Consequently, the reverse surface of the print medium P faces the transfer drum 41, transferring the ink image to the reverse surface. Further, the cleaning device 60 for cleaning the outer peripheral surface of the pressurizing drum 42 is disposed on the outer peripheral surface of the pressurizing drum 42, but the details will be described later.

The chain 8c is wound between the two sprockets 8b. One of the two sprockets 8b is a driving sprocket, and the other is a driven sprocket. The chain 8c runs cyclically by rotating the driving sprocket. The chain 8c includes a plurality of grip mechanisms spaced apart from each other in its longitudinal direction. Each grip mechanism grips the end of the printed product P′. The printed product P′ is transferred from the conveyance drum 805 positioned at a downstream end to each grip mechanism of the chain 8c, and the printed product P′ gripped by the grip mechanism is conveyed to the collection unit 8d by running the chain 8c, releasing gripping. Consequently, the printed product P′ is stacked in the collection unit 8d.

### Post Processing Unit

The conveyance apparatus 1B includes post processing units 10A and 10B. The post processing units 10A and 10B are mechanisms which are arranged on the downstream side of the transfer unit 4, and perform post processing on the printed product P′. The post processing unit 10A performs processing on the obverse surface of the printed product P′, and the post processing unit 10B performs processing on the reverse surface of the printed product P′. The contents of the post processing includes, for example, coating that aims at protection, glossy, and the like of an image on the image printed surface of the printed product P′. For example, liquid application, sheet welding, lamination, and the like can be given as an example of coating.

### Inspection Unit

The conveyance apparatus 1B includes inspection units 9A and 9B. The inspection units 9A and 9B are mechanisms which are arranged on the downstream side of the transfer unit 4, and inspect the printed product P′.

In this embodiment, the inspection unit 9A is an image capturing apparatus that captures an image printed on the printed product P′ and includes an image sensor, for example, a CCD sensor, a CMOS sensor, or the like. The inspection unit 9A captures a printed image while a printing operation is performed continuously. Based on the image captured by the inspection unit 9A, it is possible to confirm a temporal change in tint or the like of the printed image and determine whether to correct image data or print data. In this embodiment, the inspection unit 9A has an imaging range set on the outer peripheral surface of the pressurizing drum 42 and is arranged to be able to partially capture the printed image immediately after transfer. The inspection unit 9A may inspect all printed images or may inspect the images every predetermined sheets.

In this embodiment, the inspection unit 9B is also an image capturing apparatus that captures an image printed on the printed product P′ and includes an image sensor, for example, a CCD sensor, a CMOS sensor, or the like. The inspection unit 9B captures a printed image in a test printing operation. The inspection unit 9B can capture the entire printed image. Based on the image captured by the inspection unit 9B, it is possible to perform basic settings for various correction operations regarding print data. In this embodiment, the inspection unit 9B is arranged at a position to capture the printed product P′ conveyed by the chain 8c. When the inspection unit 9B captures the printed image, it captures the entire image by temporarily suspending the run of the chain 8c. The inspection unit 9B may be a scanner that scans the printed product P′.

### Control Unit

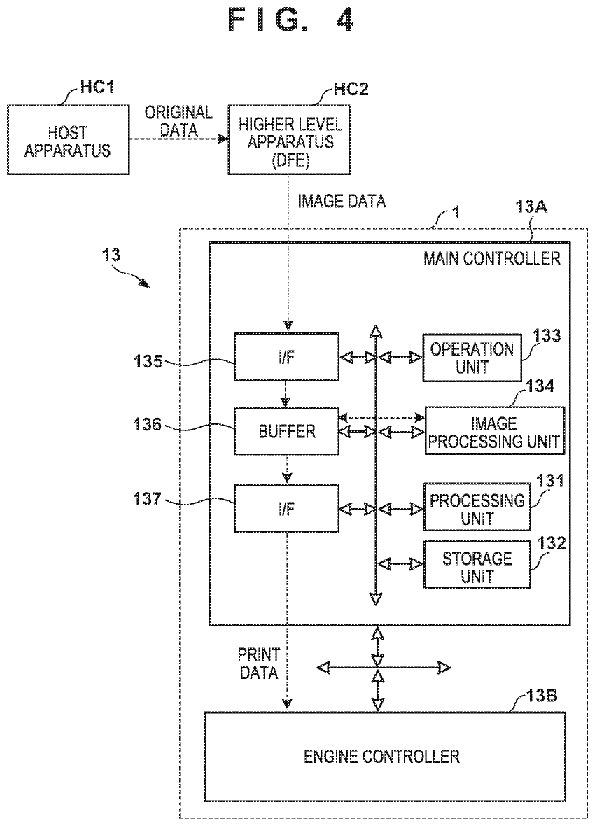

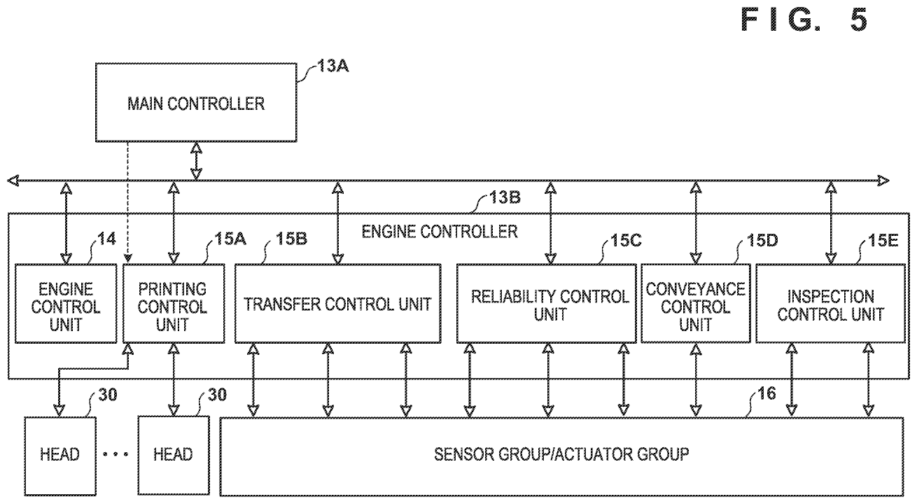

A control unit of the printing system 1 will be described next. FIGS. 4 and 5 are block diagrams each showing a control unit 13 of the printing system 1. The control unit 13 is communicably connected to a higher level apparatus (DFE) HC2, and the higher level apparatus HC2 is communicably connected to a host apparatus HC1.

Original data to be the source of a printed image is generated or saved in the host apparatus HC1. The original data here is generated in the format of, for example, an electronic file such as a document file or an image file. This original data is transmitted to the higher level apparatus HC2. In the higher level apparatus HC2, the received original data is converted into a data format (for example, RGB data that represents an image by RGB) available by the control unit 13. The converted data is transmitted from the higher level apparatus HC2 to the control unit 13 as image data. The control unit 13 starts a printing operation based on the received image data.

In this embodiment, the control unit 13 is roughly divided into a main controller 13A and an engine controller 13B. The main controller 13A includes a processing unit 131, a storage unit 132, an operation unit 133, an image processing unit 134, a communication I/F (interface) 135, a buffer 136, and a communication I/F 137.

The processing unit 131 is a processor such as a CPU, executes programs stored in the storage unit 132, and controls the entire main controller 13A. The storage unit 132 is a storage device such as a RAM, a ROM, a hard disk, or an SSD, stores data and the programs executed by the processing unit (CPU) 131, and provides the processing unit (CPU) 131 with a work area. The operation unit 133 is, for example, an input device such as a touch panel, a keyboard, or a mouse and accepts a user instruction.

The image processing unit 134 is, for example, an electronic circuit including an image processing processor. The buffer 136 is, for example, a RAM, a hard disk, or an SSD. The communication I/F 135 communicates with the higher level apparatus HC2, and the communication I/F 137 communicates with the engine controller 13B. In FIG. 4, broken-line arrows exemplify the processing sequence of image data. Image data received from the higher level apparatus HC2 via the communication I/F 135 is accumulated in the buffer 136. The image processing unit 134 reads out the image data from the buffer 136, performs predetermined image processing on the readout image data, and stores the processed data in the buffer 136 again. The image data after the image processing stored in the buffer 136 is transmitted from the communication I/F 137 to the engine controller 13B as print data used by a print engine.

As shown in FIG. 5, the engine controller 13B includes control units 14 and 15A to 15E, and obtains a detection result of a sensor group/actuator group 16 of the printing system 1 and controls driving of the groups. Each of these control units includes a processor such as a CPU, a storage device such as a RAM or a ROM, and an interface with an external device. Note that the division of the control units is merely illustrative, and a plurality of subdivided control units may perform some of control operations or conversely, the plurality of control units may be integrated with each other, and one control unit may be configured to implement their control contents.

The engine control unit 14 controls the entire engine controller 13B. The printing control unit 15A converts print data received from the main controller 13A into raster data or the like in a data format suitable for driving of the printheads 30. The printing control unit 15A controls discharge of each printhead 30.

The transfer control unit 15B controls the application unit 5A, the absorption unit 5B, and the heating unit 5C, and the cleaning unit 5D.

The reliability control unit 15C controls the supply unit 6, the recovery unit 12, and a driving mechanism which moves the print unit 3 between the discharge position POS1 and the recovery position POS3.

The conveyance control unit 15D controls driving of the transfer unit 4 and controls the conveyance apparatus 1B. The inspection control unit 15E controls the inspection unit 9B and the inspection unit 9A.

Of the sensor group/actuator group 16, the sensor group includes a sensor that detects the position and speed of a movable part, a sensor that detects a temperature, an image sensor, and the like. The actuator group includes a motor, an electromagnetic solenoid, an electromagnetic valve, and the like.

### Operation Example

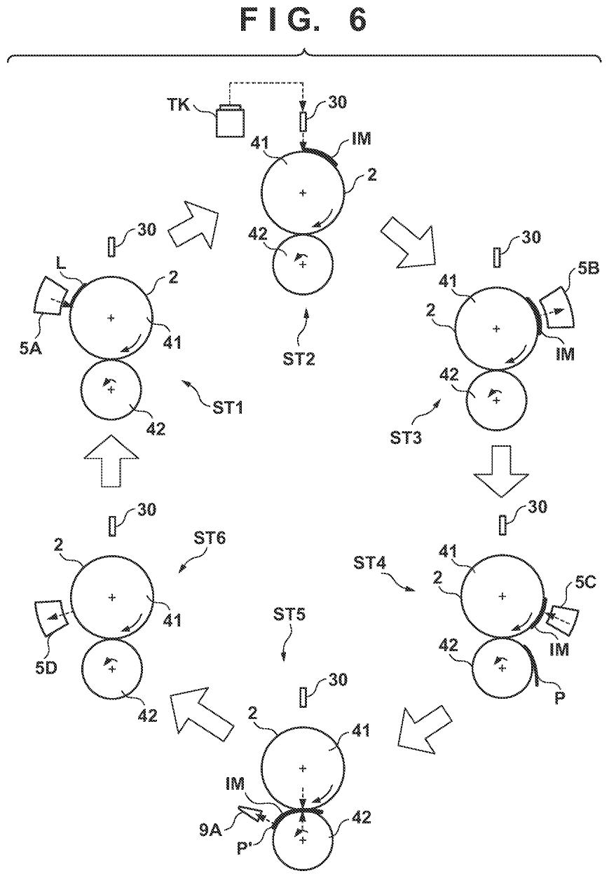

FIG. 6 is a view schematically showing an example of a printing operation. Respective steps below are performed cyclically while rotating the transfer drum 41 and the pressurizing drum 42. As shown in a state ST1, first, a reactive liquid L is applied from the application unit 5A onto the transfer member 2. A portion to which the reactive liquid L on the transfer member 2 is applied moves along with the rotation of the transfer drum 41. When the portion to which the reactive liquid L is applied reaches under the printhead 30, ink is discharged from the printhead 30 to the transfer member 2 as shown in a state ST2. Consequently, an ink image IM is formed. At this time, the discharged ink mixes with the reactive liquid L on the transfer member 2, promoting coagulation of the coloring materials. The discharged ink is supplied from the reservoir TK of the supply unit 6 to the printhead 30.

The ink image IM on the transfer member 2 moves along with the rotation of the transfer member 2. When the ink image IM reaches the absorption unit 5B, as shown in a state ST3, the absorption unit 5B absorbs a liquid component from the ink image IM. When the ink image IM reaches the heating unit 5C, as shown in a state ST4, the heating unit 5C heats the ink image IM, a resin in the ink image IM melts, and a film of the ink image IM is formed. In synchronism with such formation of the ink image IM, the conveyance apparatus 1B conveys the print medium P.

As shown in a state ST5, the ink image IM and the print medium P reach the nip portion between the transfer member 2 and the pressurizing drum 42, the ink image IM is transferred to the print medium P, and the printed product P′ is formed. Passing through the nip portion, the inspection unit 9A captures an image printed on the printed product P′ and inspects the printed image. The conveyance apparatus 1B conveys the printed product P′ to the collection unit 8d.

When a portion where the ink image IM on the transfer member 2 is formed reaches the cleaning unit 5D, it is cleaned by the cleaning unit 5D as shown in a state ST6. After the cleaning, the transfer member 2 rotates once, and transfer of the ink image to the print medium P is performed repeatedly in the same procedure. The description above has been given such that transfer of the ink image IM to one print medium P is performed once in one rotation of the transfer member 2 for the sake of easy understanding. It is possible, however, to continuously perform transfer of the ink image IM to the plurality of print media P in one rotation of the transfer member 2.

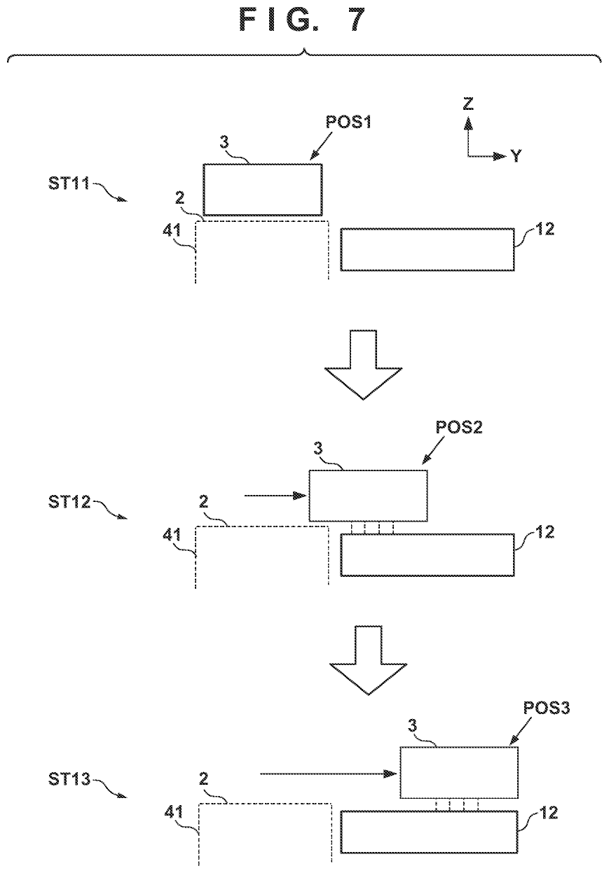

Each printhead 30 needs maintenance if such a printing operation continues. FIG. 7 shows an operation example at the time of maintenance of each printhead 30. A state ST11 shows a state in which the print unit 3 is positioned at the discharge position POS1. A state ST12 shows a state in which the print unit 3 passes through the preliminary recovery position POS2. Under passage, the recovery unit 12 performs a process of recovering discharge performance of each printhead 30 of the print unit 3. Subsequently, as shown in a state ST13, the recovery unit 12 performs the process of recovering the discharge performance of each printhead 30 in a state in which the print unit 3 is positioned at the recovery position POS3.

### Cleaning Device of Pressurizing Drum

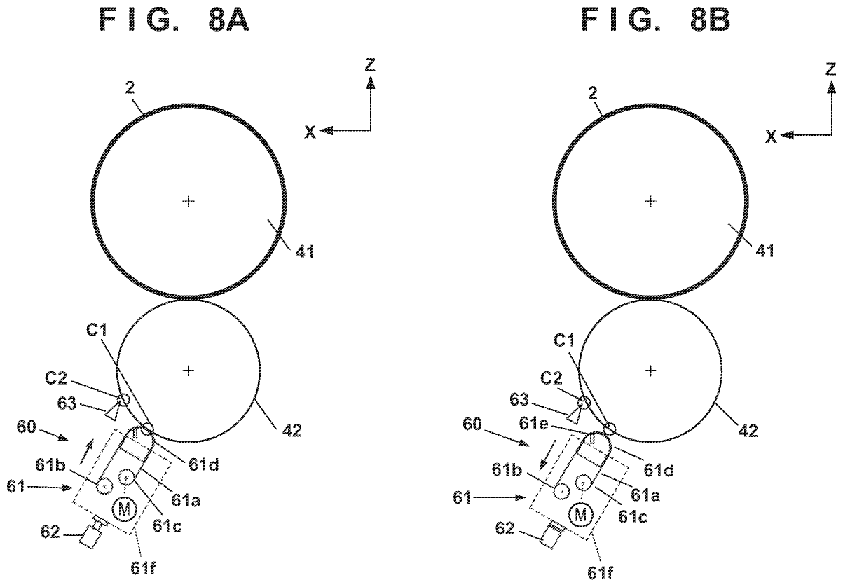

With reference to FIGS. 8A and 8B, the cleaning device 60 for cleaning the pressurizing drum 42 will be described. FIG. 8A is a view showing a state in which the cleaning device 60 is in contact with the pressurizing drum 42, and FIG. 8B is a view showing a state in which the cleaning device 60 and the pressurizing drum 42 are separated. For example, the application unit 5A applies a reaction liquid onto the transfer member 2, but it may apply the reaction liquid to a region wider than the width of the print medium P of the largest size so that the reaction liquid can be applied to the entire region of the transfer member 2 where it contacts the print medium P. In such a case, when the pressurizing drum 42 is brought into tight contact with the transfer member 2, a liquid or the like (for example, the reaction liquid) on the surface of the transfer member 2 may be transferred to the pressurizing drum 42 in the region where the print medium P does not exist. By providing the cleaning device 60, the peripheral surface of the pressurizing drum 42 can be maintained clean.

The cleaning device 60 of this embodiment includes a cleaning unit 61 that cleans the pressurizing drum 42 at a cleaning position C1, and a displacing unit 62 that brings the cleaning unit 61 into contact with and separates it from the pressurizing drum 42. In this embodiment, since the cleaning position C1 of the cleaning unit 61 is arranged on the conveyance path of the print medium P, the print medium P passes the cleaning position C1 during a printing operation. In this embodiment, when the print medium P passes the cleaning position, the displacing unit 62 separates the cleaning unit 61 and the pressurizing drum 42 from each other, making it possible to clean the pressurizing drum 42 while avoiding interference with the print medium P during a printing operation.

The cleaning unit 61 includes a cleaning member 61a, a supply reel 61b, a winding reel 61c, a head 61d, a nozzle 61e, a driving source M, and a support member 61f. The cleaning member 61a cleans the peripheral surface of the pressurizing drum 42 by contacting the peripheral surface of the pressurizing drum 42. In this embodiment, the cleaning member 61a is a cloth. The cloth is, for example, a long band-like non-woven fabric, and is wound around the supply reel 61b and the winding reel 61c. The cleaning member 61a has a width capable of cleaning the pressurizing drum 42 entirely in the Y direction.

An unused portion of the cleaning member 61a is wound around the supply reel 61b, and a used portion of the cleaning member 61a is wound around the winding reel 61c. Each of the supply reel 61b and the winding reel 61c is a rotating member supported rotatably about an axis in the Y direction, and the winding reel 61c is rotated by a driving force of the driving source M such as a motor. When the winding reel 61c is rotated, the cleaning member 61a is wound by the winding reel 61c, while the supply reel 61b is driven to rotate and the cleaning member 61a is delivered from the supply reel 61b. During the cleaning operation of the pressurizing drum 42, the unused portion of the cleaning member 61a can be brought into contact with the pressurizing drum 42.

The head 61d is a member that brings the cleaning member 61a into contact with the pressurizing drum 42 at a midway portion of the cleaning member 61a between the supply reel 61b and the winding reel 61c, and supports the cleaning member 61a from the back side. The surface of the distal end of the head 61d is a semicircular curved surface, and the cleaning member 61a is supported on the curved surface. The nozzle 61e for discharging a cleaning liquid is provided inside the head 61d. The nozzle 61e discharges the cleaning liquid to the cleaning member 61a. Thus, the cleaning member 61a is impregnated with the cleaning liquid. The cleaning liquid is, for example, pure water. As a method of impregnating the cleaning member 61a with the cleaning liquid, in addition to the method using the nozzle 61e, an arrangement in which the cleaning member 61a is passed through a reservoir reserving the cleaning liquid can also be adopted.

The support member 61f is a member for supporting the supply reel 61b, the winding reel 61c, the driving source M, and the head 61d. The support member 61f supports each of the supply reel 61b and the winding reel 61c rotatably about the axis in the Y direction. The head 61d is fixed to the support member 61f. A buffer member such as a spring may be interposed between the head 61d and the support member 61f to reduce the impact upon contacting the pressurizing drum 42.

The displacing unit 62 is a unit which displaces the cleaning unit 61 and is, for example, an electrically-driven cylinder. In this embodiment, the displacement of the displacing unit 62 is controlled by the conveyance control unit 15D. The displacing unit 62 displaces the cleaning unit 61 in the directions of the arrows in FIGS. 8A and 8B between the cleaning position C1 (FIG. 8A) where the cleaning member 61a is in contact with the peripheral surface of the pressurizing drum 42 and the retracted position (FIG. 8B) where the cleaning member 61a is separated from the peripheral surface of the pressurizing drum 42. Thus, when the cleaning unit 61 is moved by the displacing unit 62 to the cleaning position C1 where it is in contact with the pressurizing drum 42, the cleaning unit 61 cleans the pressuring drum 42.

A detecting unit 63 is provided upstream of the cleaning device 60 in the conveyance direction, and detects the entrance of the print medium P to the cleaning position C1 at a detection position C2 upstream of the cleaning position C1 in the conveyance direction. The detecting unit 63 is, for example, a photoelectric sensor including a light emitting unit and a light receiving unit. In this embodiment, when the detecting unit 63 does not detect the entrance of the printing medium P to the cleaning position C1, the displacing unit 62 brings the cleaning unit 61 into contact with the pressurizing drum 42 so as to clean the pressurizing drum 42, as shown in FIG. 8A. On the other hand, when the detecting unit 63 detects the entrance of the print medium P to the cleaning position C1, the displacing unit 62 separates the cleaning unit 61 from the pressurizing drum 42, as shown in FIG. 8B. Thus, the pressurizing drum 42 can be cleaned while avoiding interference with the print medium P during the printing operation.

### Conveyance Path of Print Medium

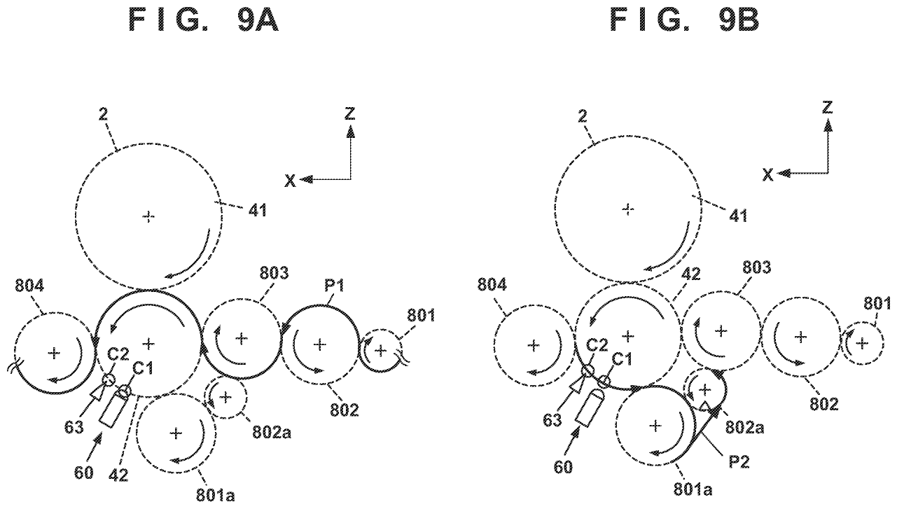

With reference to FIGS. 1 and 9, the conveyance path of the print medium P will be described. FIG. 9A is a view showing a conveyance path P1 through which the print medium P passes when performing printing on the print medium P, and FIG. 9B is a view showing a conveyance path P2 through which the print medium P passes when the print medium P is reversed and conveyed again to a printing position after printing on the obverse surface at the time of double-sided printing.

The conveyance path P1 passes the conveyance cylinders 801, 802, and 803, the pressurizing drum 42, and the conveyance drum 804 as shown by the arrows, and connects to the conveyance drum 805 located further downstream. When the print medium P passing through the conveyance path P1 passes the upper side of the pressurizing drum 42 in the Z direction, the transfer unit 4 transfers an ink image on the transfer member 2. At the time of single-sided printing, the print medium P having the ink image transferred thereto passes through the conveyance path P1 and is conveyed to the conveyance drum 805 located downstream.

On the other hand, at the time of double-sided printing, after the ink image is transferred to the obverse surface of the print medium P, it is necessary to reverse the print medium P and to transfer an ink image to the reverse surface. In such a case, after passing the conveyance drums 801, 802, and 803, and the pressurizing drum 42 along the conveyance path P1 and having the ink image transferred to the obverse surface, the print medium P enters the conveyance path P2. The conveyance path P2 passes the conveyance drums 801a and 802a from the lower side of the pressurizing drum 42, and connects to the conveyance path P1 from the lower side of the conveyance drum 803. When the print medium P having entered the conveyance path P2 is transferred from the conveyance drum 801a to the conveyance drum 802a, the print medium P is reversed. When the print medium P having entered the conveyance path P1 from the lower side of the conveyance drum 803 after the reversal passes the upper side of the pressurizing drum 42, an ink image is transferred to the reverse surface. Then, the print medium P passes the conveyance drum 804 and is conveyed to the conveyance drum 805 located downstream.

Thus, the conveyance apparatus 1B includes different conveyance paths: one for single-sided printing and the other for double-sided printing. In particular, focusing on the pressurizing drum 42, the print medium P passes the upper part of the pressurizing drum 42 included in the conveyance path P1 during single-sided printing and double-sided printing, but the print medium P passes the lower part of the pressurizing drum 42 included in the conveyance path P2 only during double-sided printing.

In this embodiment, the cleaning position C1 of the cleaning device 60 is a position on the conveyance path (on P2). Therefore, the print medium P does not pass the cleaning position C1 at the time of single-sided printing. Accordingly, the cleaning device 60 can always clean the pressurizing drum 42 during a printing operation at the time of single-sided printing, and can clean the pressurizing drum 42 while avoiding interference with the print medium P at the time of double-sided printing. In addition, in this embodiment, the detection position C2 of the detecting unit 63 is a position on the conveyance path (on P2). Therefore, since the detecting unit 63 does not detect the print medium P during single-sided printing, the cleaning device 60 can always clean the pressurizing drum 42. At the time of double-sided printing, the detecting unit 63 detects the entrance of the print medium at the detection position C2, so that the cleaning device can clean the pressurizing drum 42 while avoiding interference with the print medium P.

### Arrangement of Gripping Unit

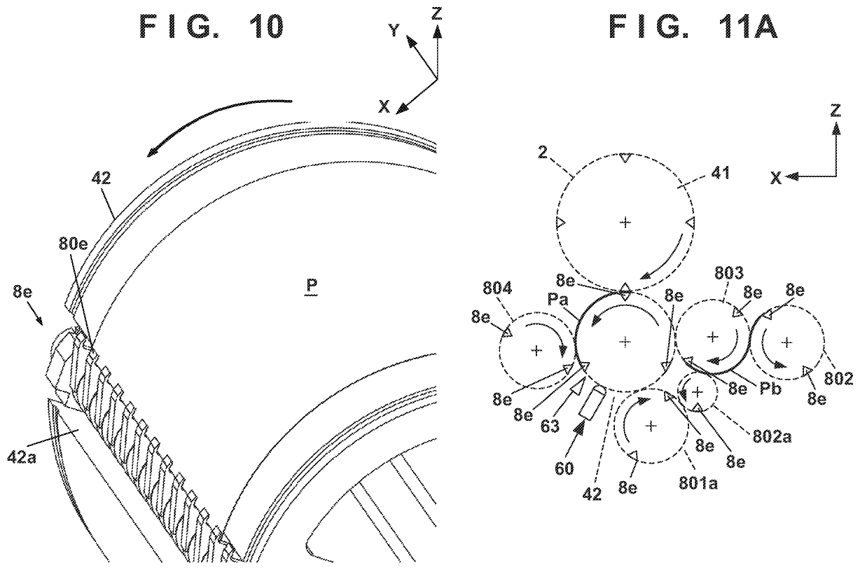

FIG. 10 is a perspective view showing the arrangement of the gripping unit 8e, and shows the gripping unit 8e provided on the pressurizing drum 42. The arrow in FIG. 10 indicates the rotation direction of the pressurizing drum 42. At least one gripping unit 8e is provided on the outer peripheral surface of each of the pressurizing drum 42 and the conveyance drums 801 to 805, 801a, and 802a, and a gripping operation and release operation of each gripping unit are controlled such that the print medium P is transferred between the adjacent conveyance drums.

In this embodiment, the gripping unit 8e is provided in a groove 42a of the pressurizing drum 42, and includes a gripper 80e for gripping the leading end of the print medium P and a driving unit (not shown) for driving the gripper 80e. The driving unit is, for example, an electrically-driven motor. The driving unit drives the gripper 80e to grip or release the print medium P, allowing the print medium P to be transferred between the adjacent conveyance drums.

The pressurizing drum 42 only needs to include at least one gripping unit 8e. However, the pressurizing drum 42 may include an odd number of gripping units 8e separated in the circumferential direction of the pressurizing drum such that an odd number of print media P can be simultaneously gripped in the circumferential direction. By including the odd number of gripping units 8e, the pressurizing drum 42 can simultaneously convey the odd number of print media P. In this embodiment, the pressurizing drum 42 includes three gripping units 8e, and can simultaneously convey three print media.

### Flow of Print Medium at the Time of Double-Sided Printing

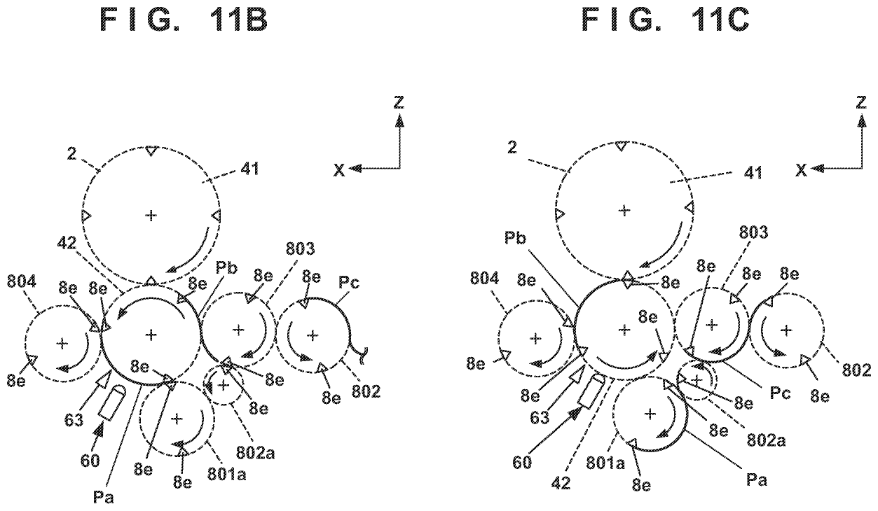

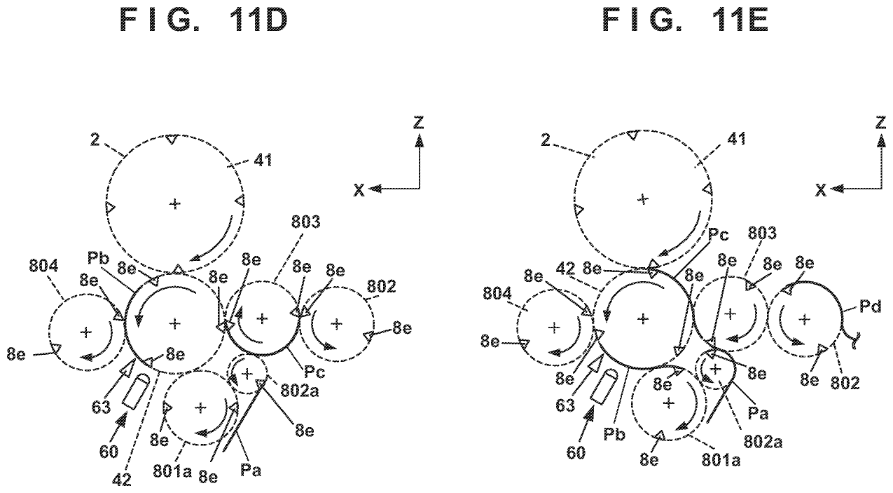

FIGS. 11A to 11E are explanatory views showing the flow of the print medium P at the time of double-sided printing. Note that in FIGS. 11A to 11E, the print media are denoted by the reference numerals Pa, Pb, Pc, and Pd in the order of feeding from the feeding unit 7.

As shown in FIGS. 1 and 11A, the feeding unit 7 feeds a first print medium Pa to the conveyance apparatus 1B, and subsequently feeds a second print medium Pb to the conveyance apparatus 1B. The gripping unit 8e of each of the pressurizing drum 42 and the conveyance drums 801 to 805, 801a, and 802a grips the leading end of each of the first print medium Pa and the second print medium Pb fed to the conveyance apparatus 1B, conveying the print media Pa and Pb in the rotation directions of the pressurizing drum 42 and the conveyance drums 801 to 805, 801a, and 802a. At this time, the feeding unit 7 intermittently feeds the second print medium Pb and the third and subsequent print media Pc and Pd to the conveyance apparatus 1B such that every other gripping unit 8e of the pressurizing drum 42 can grip the print medium.

The first print medium Pa passes the upper side of the pressurizing drum 42 along the conveyance path P1 shown in FIG. 9A and an ink image is transferred to the obverse surface. Then, for performing double-sided printing, the first print medium Pa is conveyed to the lower side of the pressurizing drum 42 along the conveyance path P2 shown in FIG. 9B (FIG. 11B). Thereafter, the first print medium Pa is transferred from the pressurizing drum 42 to the conveyance drum 801a (FIG. 11C), and is reversed when transferred to the conveyance drum 802a (FIG. 11D).

The first print medium Pa enters the conveyance path P1 from the lower side of the conveyance drum 803 after being reversed but, at this time, enters between the third print medium Pc and the fourth print medium Pd (FIG. 11E). Since the feeding unit 7 intermittently feeds the print media Pa to Pd such that every other gripping unit 8e of the pressurizing drum 42 grips one of the print media Pa to Pd, the first print medium Pa can enter between the third print medium Pc and the fourth print medium Pd when entering the conveyance path P1 from the conveyance path P2 (FIG. 11E). Therefore, at the time of double-sided printing, printing on the obverse surface and printing on the reverse surface can be alternately and continuously performed.

### Operation of Cleaning Device

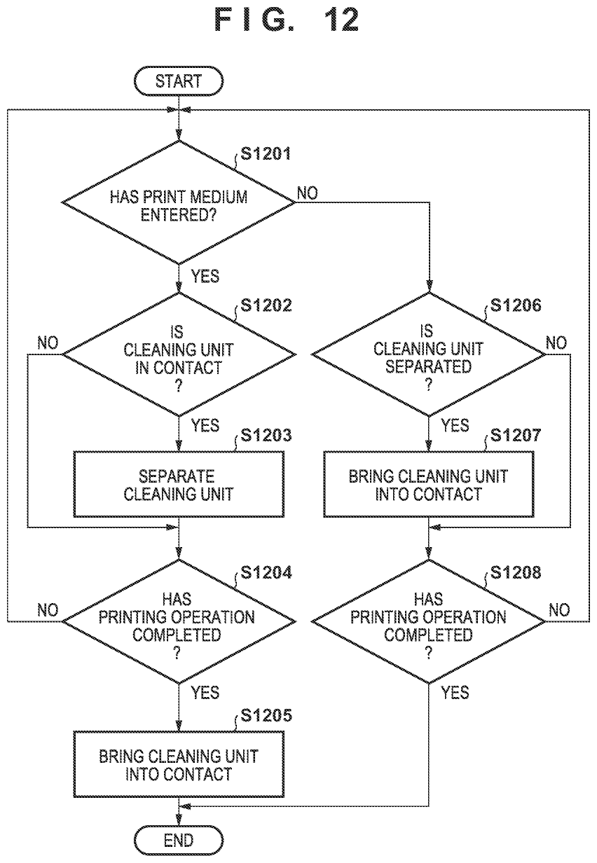

FIG. 12 is a flowchart showing the operation of the cleaning device 60. In this embodiment, the operation of the cleaning device 60 is controlled by the conveyance control unit 15D. This flowchart starts when an operation of printing on the print medium P is started. At the start, the cleaning unit 61 is in contact with the pressurizing drum 42.

In step S1201, the conveyance control unit 15D determines, based on the detection result of the detecting unit 63, whether the print medium P enters the cleaning position C1. If it is determined that the print medium P enters the cleaning position C1, the conveyance control unit 15D advances to processing in step S1202. If it is determined that the print medium P does not enter the cleaning position C1, the conveyance control unit 15D advances to processing in step S1206.

In step S1202, if the cleaning unit 61 is in contact with the pressurizing drum 42, the conveyance control unit 15D advances to processing in step S1203 and controls the displacing unit 62 to separate the cleaning unit 61 from the pressurizing drum 42. Then, the conveyance control unit 15D advances to processing in step S1204. On the other hand, if the cleaning unit 61 is not in contact with the pressurizing drum 42 in step S1202, the conveyance control unit 15D advances to processing in step S1204.

In step S1204, if the printing operation is completed, the conveyance control unit 15D controls the displacing unit 62 in step S1205 to bring the cleaning unit 61 into contact with the pressurizing drum 42, and terminates the process. On the other hand, if the printing operation is not completed in step S1204, the conveyance control unit 15D returns to processing in step S1201.

In the case of advancing from step S1201 to step S1206, if the cleaning unit 61 is separated from the pressurizing drum 42, the conveyance control unit 15D advances to processing in step S1207 and controls the displacing unit 62 to bring the cleaning unit 61 into contact with the pressurizing drum 42. Then, the conveyance control unit 15D advances to processing in step S1208. On the other hand, if the cleaning unit 61 is not separated from the pressurizing drum 42 in step S1206, the conveyance control unit 15D advances to processing in step S1208.

In step S1208, if the printing operation is completed, the conveyance control unit 15D terminates the process. On the other hand, if the printing operation is not completed, the conveyance control unit 15D returns to processing in step S1201.

With the above operation, the cleaning device 60 can clean the pressurizing drum 42 while avoiding interference with the print medium P during the printing operation.

### Second Embodiment

In the first embodiment, the printing system 1 is a transfer-type inkjet printer that transfers an ink image to the print medium P via the transfer member 2. However, an arrangement in which the print unit 3 discharges ink directly onto a print medium P can also be adopted. A printing system 130 according to the second embodiment will now be described. The components similar to those in the first embodiment are denoted by the same reference numerals and a description thereof will be omitted.

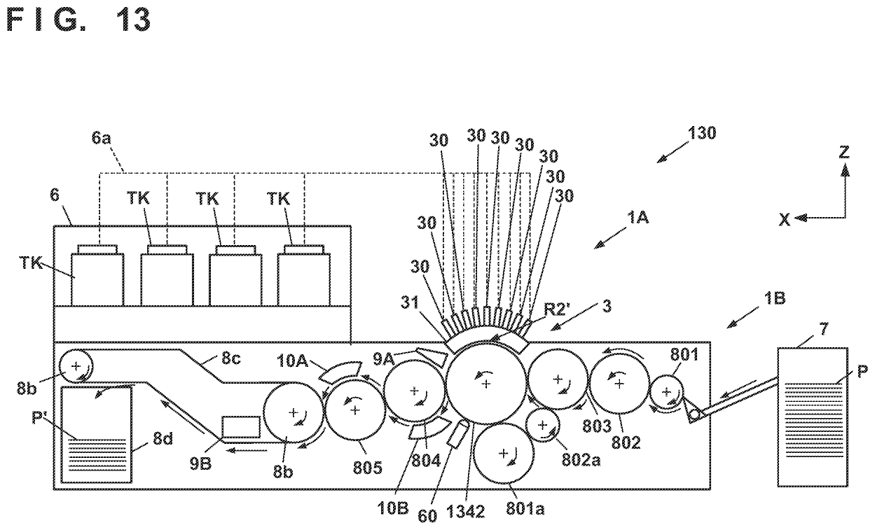

FIG. 13 is a schematic view of the printing system 130 in the second embodiment. The second embodiment is different from the first embodiment in that the transfer unit 4 and the peripheral units 5A to 5D are not provided. In addition, a conveyance drum 1342 is provided instead of the pressurizing drum 42. The conveyance drum 1342 conveys a print medium P to a discharge area R2′ of a print unit 3.

In the discharge area R2′, when the print unit 3 discharges ink onto the print medium P, the ink may adhere to the conveyance drum 1342 conveying the print medium P. If there is a deposit on the conveyance drum 1342, the conveyed print medium P may be stained.

Therefore, by providing a cleaning device 60 for cleaning the conveyance drum 1342, the deposit adhered to the conveyance drum 1342 can be removed, making it possible to prevent staining the print medium P. In addition, by adopting the arrangement similar to that in the first embodiment, it is possible to clean the conveyance drum 1342 while avoiding interference with the print medium P during a printing operation.

### Another Embodiment

In the above embodiments, the print unit 3 includes the plurality of printheads 30. However, a print unit 3 may include one printhead 30. The printhead 30 may not be a full-line head but may be of a serial type that forms an ink image by discharging ink from the printhead 30 while a carriage that mounts the printhead 30 detachably moves in a Y direction.

A conveyance mechanism of a print medium P may adopt another method such as a method of clipping and conveying the print medium P by a pair of rollers. In the method of conveying the print medium P by the pair of rollers or the like, a roll sheet may be used as the print medium P, and a printed product P′ may be formed by cutting the roll sheet after transfer.

In the above embodiments, the transfer member 2 is provided on the outer peripheral surface of the transfer drum 41. However, another method such as a method of forming a transfer member 2 into an endless swath and cyclically rotating and moving it may be used.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefits of Japanese Patent Application No. 2018-148706, filed Aug. 7, 2018, which is hereby incorporated by reference herein in its entirety.

What is claimed is:

1. A printing apparatus comprising:
a transfer member configured to cyclically pass a formation area and a transfer area of an ink image;
a print unit configured to form an ink image on the transfer member by discharging ink to the transfer member in the formation area;
a conveyance drum configured to convey a print medium and to which an ink image is transferred from the transfer member in the transfer area;
a cleaning unit configured to clean the conveyance drum at a cleaning position where the cleaning unit contacts the conveyance drum; and
a displacing unit configured to separate the cleaning unit from the cleaning position when the print medium passes the cleaning position.

2. The printing apparatus according to claim 1, further comprising a conveyance unit including the conveyance drum and configured to reverse the print medium conveyed by the conveyance drum through a predetermined conveyance path and to convey the print medium to a printing position when printing on a reverse surface of the print medium is performed after printing on an obverse surface thereof,
wherein the cleaning position by the cleaning unit is a position on the predetermined conveyance path.

3. The printing apparatus according to claim 1, further comprising a detecting unit configured to detect the print medium entering the cleaning position.

4. The printing apparatus according to claim 2, further comprising a detecting unit configured to detect that the print medium enters the cleaning position,
wherein a detection position of the detecting unit is a position on the conveyance path and upstream of the cleaning position in a conveyance direction of the print medium.

5. The printing apparatus according to claim 1, wherein the cleaning unit comprises a cleaning member, and the cleaning member contacts the conveyance drum at the cleaning position.

6. The printing apparatus according to claim 2, further comprising a feeding unit configured to feed the print medium,
wherein the conveyance drum comprises a plurality of gripping units separated in a circumferential direction of the conveyance drum such that an odd number of print media can be simultaneously gripped in the circumferential direction, and
the feeding unit feeds the print medium such that, when performing printing on the obverse surface and the reverse surface of the print medium, every other gripping unit in the circumferential direction grips the print medium in the conveyance drum,

7. The printing apparatus according to claim 1, further comprising a transfer drum configured to support the transfer member,
wherein the conveyance drum is a pressurizing drum arranged facing the transfer drum.

8. A cleaning device configured to clean a conveyance drum that conveys a print medium in a printing apparatus, wherein
the printing apparatus includes:
a transfer member configured to cyclically pass a formation area and a transfer area of an ink image; and
a print unit configured to form an ink image on the transfer member by discharging ink to the transfer member in the formation area,
an ink image is transferred from the transfer member to the conveyance drum in the transfer area, and
the cleaning device comprises:
a cleaning unit configured to clean the conveyance drum; and
a displacing unit configured to separate the cleaning unit from the conveyance drum when the print medium passes a position where the cleaning unit cleans the conveyance drum.

9. A printing method of a printing apparatus,
the printing apparatus including:
a transfer member configured to cyclically pass a formation area and a transfer area of an ink image;
a print unit configured to form an ink image on the transfer member by discharging ink to the transfer member in the formation area; and
a conveyance drum configured to convey a print medium and to which an ink image is transferred from the transfer member in the transfer area,
the printing method comprising:
printing an image on a print medium while conveying the print medium by a conveyance drum;
cleaning the conveyance drum; and
displacing by separating a cleaning unit configured to clean the conveyance drum from the conveyance drum when the print medium passes a cleaning position of the conveyance drum in the cleaning.
